(19) United States
(12) Patent Application Publication
(10) Pub. No.: US 2026/0073356 A1
(43) Pub. Date: Mar. 12, 2026

(54) SECURE AND CONFIDENTIAL COLLABORATION ARCHITECTURE

(71) Applicant: Raytheon Company, Tewksbury, MA (US)

(72) Inventors: Frederick K. Jones, Tucson, AZ (US); James D. Moreland, King George, VA (US)

(21) Appl. No.: 18/882,617

(22) Filed: Sep. 11, 2024

(51) Int. Cl. G06Q 10/10; G06Q 50/18

(52) U.S. Cl. CPC G06Q 10/103; G06Q 50/184

(57) ABSTRACT

Systems, devices, methods, and computer-readable media for secure, federated collaboration are provided. A method can include responsive to issuing an acceptance of an enrollment request, providing, by a collaboration architecture, software programs including first and second machine learning (ML) models and collaboration services to the first collaborator, the first ML model trained to monitor an intellectual property (IP) repository of the first collaborator for changes to data stored thereon, the second ML model trained based on IP goals of the second collaborator, receiving, from the second collaborator, a communication indicating interest in the IP associated with IP data of the first collaborator, responsive to receive the communicating indicating interest, prompting a large language model (LLM), to generate a collaboration agreement regarding the IP data that changed, and receiving an executed collaboration agreement at the collaboration architecture.

### TECHNICAL FIELD

Aspects regard computer architectures for secure and confidential collaboration between multiple entities.

### BACKGROUND

Currently, entity collaboration is ad hoc and labor intensive. Discovery of suitable collaboration partners (e.g., individuals, businesses, universities, non-profit organizations, or the like) is manual and relies on knowledge specific to individuals. The collaboration process is often hindered by negotiations of non-disclosure agreement terms, intellectual property (IP) protections and licensing agreements, proprietary information agreements (PIA), and establishing collaboration services. The collaboration services include electronic mail (email), instant messaging (IM), data repositories, billing channels, etc.

After the collaboration is established, NDA and PIA violations are monitored. The monitoring includes identifying violations. Such violations cause changes in the relationship between the entities, sometimes making the relationship adversarial rather than friendly. These relationship changes can fuel or hinder the goals of the entities.

Very often, entity interfaces and the data flows between them are not modeled, understood, or managed. Often, an entity is unable to identify a subject matter expert (SME), decision maker, relevant process, or relevant policy that governs a given situation. System and other engineers are focused on technical interfaces between components and do not focus on the interfaces, processes, and policies that govern and control the interactions between entities (e.g., legal entities or other organized groups of people that have goals).

Currently, there is no computer-based ability to create and foster teaming relationships to solve mission engineering problems. The current processes are human intensive, such as to resolve differences in legal agreements. Social networks are focused on individuals & marketing, such as for connecting individuals with job opportunities and other likeminded individuals for example. These social networks are not focused on connecting groups of people together to solve mission engineering problems.

### BRIEF DESCRIPTION OF DRAWINGS

FIG. 1 illustrates, by way of example, a flow diagram of communications for onboarding and using a collaboration architecture.

FIG. 2 illustrates, by way of example, a diagram of communications and operations for using the collaboration architecture.

FIG. 3 illustrates, by way of example, a diagram of an embodiment of a system 300 for enabling the collaboration of FIGS. 1 and 2.

FIG. 4 illustrates, by way of example, a diagram of an embodiment of a method for secure, federated collaboration.

FIG. 5 is a block diagram of an example of an environment including a system for neural network (NN) training.

FIG. 6 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Embodiments provide an architecture that provides a process for entity-to-entity collaboration. An entity is a group or collective of people that work together to achieve a goal. The goal can be wide ranging, such as to include solving a problem, generating a product, constructing a road, building, waterway, or the like, among other goals. Embodiments allow the entities to discover collaboration partners through business data flow modeling, United States Patent and Trademark Office (USPTO) patent categories and/or other sources providing technology classifications, entity-to-entity legal negotiations, establishing secure communications, detecting data compromise after delivery to third party, decentralized storage and messaging, entity-to-entity payment (purchase order and invoicing) system, among others. Embodiments can use privacy-enhancing technologies for securing corporate proprietary information. Embodiments can use Web3 (de-centralized trust/identity/storage) for multi-party cybersecurity compliance.

Embodiments allow entities to follow up after meeting a potential collaboration partner, determine which other entities operate in a given technology space and whether they are open to collaboration. Embodiments allow entities of a supply chain to communicate directly with each other rather than indirectly through the entities they interact with directly. Embodiments make legal negotiations between entities easier and more streamlined. Embodiments allow entity-to-entity collaboration to generate a publication. Embodiments allow entities to identify and collaborate with potential licensing partners and to provide the secure data and communication channels to securely share data and other information. Embodiments allow an entity to discover other entities that can help them solve technical problems and pay them securely.

Embodiments can operate by generating custom prompts to a large language model (LLM) that teach the LLM the restrictions on data exchanges between entities. Restrictions can include government security classification, international import and export controls, data privacy and security certification (e.g., cybersecurity maturity model certification (CMMC), Health Insurance Portability and Accountability Act (HIPAA), General Data Protection Regulation (GDPR), Payment Card Industry (PCI) Data Security Standard (DSS), Gramm Leach Bliley Act (GLBA), Family Educational Rights and Privacy Act (FERPA)), taxation category for incorporated entity, certification to quality standards such as international organization for standardization (ISO) requirements, among others. The LLM can be prompted to generate legally sound NDAs, IPAs, license agreements, or other legal agreements. Embodiments provide encrypted peer-to-peer chat capabilities for collaboration and sharing of data in a secure manner. Embodiments allow all the data shared to remain under control of the owner without allowing the data to be stored elsewhere, such as on another entity's storage device. The LLM can be prompted to assist in negotiating license agreements and generate agreements that are plausibly acceptable to all parties involved. Embodiments allow an entity to discover another entity with the technical expertise needed to satisfy the goal, such as upgrading, decomposing, reorienting, augmenting, or operating a component.

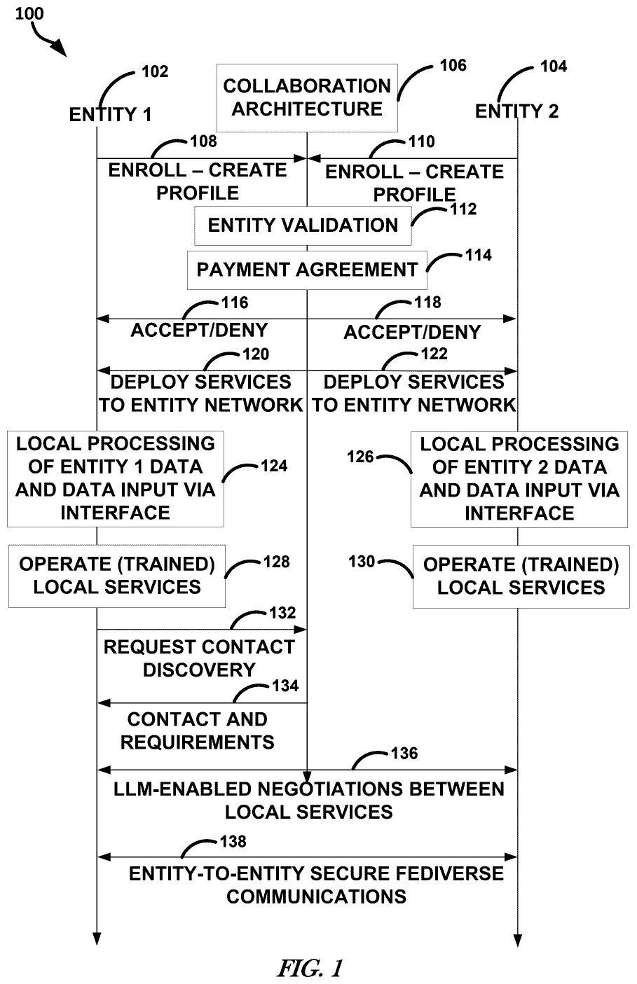

FIG. 1 illustrates, by way of example, a flow diagram of communications 100 for onboarding and using a collaboration architecture 106. The communications 100 are between a first entity 102, a second entity 104, and a collaboration architecture 106, either directly or indirectly. The entities 102, 104 issue enrollment requests 108, 110, respectively. The entities 102, 104 provide required enrollment information with the enrollment requests 108, 110. The enrollment information can include a username, password, requirements for collaborating, interest areas, or the like. The enrollment information can include a service tier (which services of the collaboration architecture the entity 102, 104 wishes to access), current agreements to which the entities 102, 104 are bound, legal representative accounts, or the like. The enrollment information can include data describing the entity (e.g., a North American Industry Classification System (NAICS) code, information constraints, payment options, other constraints).

The collaboration architecture 106 can perform entity validation 112 based on the information in the enrollment requests 108, 110. The validation 112 can include verifying whether the entity 102, 104 is indeed who they say they are. The validation 112 can include cryptographic techniques of entity validation, questions that can help verify the veracity of the entity 102, 104, or the like. The validation can include verifying an authenticity of a company identity, such as by a System for Award Management (SAM) Unique Entity ID.

The collaboration architecture 106 can establish a payment agreement 114 with each of the entities 102, 104. The payment agreement 114 can include information on how to pay in accord with collaboration agreements. The payment agreement 114 can include data indicating from where the money for payment is to be drawn. The information associated with the payment agreement 114 can be stored in a hardware encrypted device.

The collaboration architecture 106 can either accept or deny 116, 118 the enrollment request 108, 110 based on the entity validation 112 and the payment agreement 114. The acceptance or denial can be rule based. The rules can be generated by a subject matter expert that understands the operation and goals of the collaboration architecture 106.

If the collaboration architecture 106 accepts enrollment of the entity 102, 104, the collaboration architecture 106 can deploy services 120, 122 to a computer network of the entity 102, 104. The services that are deployed are determined based on the enrollment request 108, 110. The services can include software that includes a machine learning (ML) model, an interface to request collaboration partners and provide data to the collaborations partners, an encrypted direct messaging service, a payment interface, a combination thereof, or the like.

The deployed services can include an ML model that is fine tuned based on data of the entity 102, 104, respectively. The deployed ML model can be fine tuned, further based on data provided by a user of the entity providing data through a user interface (UI) to the ML model. The ML model can operate to generate prompts that are designed to cause an LLM to perform tasks. The prompts can include descriptions of the capabilities, resources available to the entity, goals, intellectual property owned, or other relevant information about the entity. The prompts can be for the LLM to discover potential collaborators among other entities that have registered with the collaboration architecture 106.

Local processing of entity data 124, 126 and data input via a UI can be used for training one or more ML models. Operating (trained) local services 128, 130 can include discovery of collaboration partners, supply chain partners, or the like, mining of information available within the collaboration architecture 106, such as publicly available and/or info marked as discoverable by entities fitting the profile of the entity 102, 104. The discovery can be through the LLM of the collaboration architecture 106 interfacing with the USPTO category system - companies who are innovating in an IP space (via public patent query and/or content marked discoverable by content owner). In some embodiments, the discovery can be through the LLM of the collaboration architecture 106 interfacing with a variety of other databases that may provide information indicating the technologies and innovations that companies are investing in.

The entity 102 can issue a entity discovery prompt in a contact discovery request 132. The LLM can access entity data including private, proprietary, IP, or other information of the entities that have registered with the collaboration architecture 106. The LLM can identify, based on this entity data, whether there is an entity that can be a collaboration partner for the entity that issued the contact discovery request 132. If the LLM identifies an entity as a potential collaborator, the LLM can return the entity and requirements 134 for working with the entity. The entity and requirements 134 can include the capabilities, resources available to the entity, goals, intellectual property owned, or other relevant information about the entity. The entity and requirements 134 can include information relevant to opening communication with the entity, such as a username, email address, phone number, or the like.

After the entities 102, 104 are connected, they can communicate with each other using encryption keys and the deployed services under the constraints defined by the requirements of the entities 102, 104. After the entities 102, 104 have agreed, the entities 102, 104 can negotiate agreements 136, via the LLM that is accessible through the collaboration architecture 106. Also, after the entities are connected, they can issue communications 138 directly to each other through a fediverse available through their local services. Each entity hosts their own sort of social networking site (the deployed local services 120, 122).

While a traditional social networking service will host all its content on servers managed by the owner of the website, decentralized servers that make up the fediverse allow any individual or organization to host their own servers (referred to as an “instance”). Every instance is independent, and can set its own rules and expectations. Even so, much like how users of one email service can still send emails to users of another service, users may still view content and interact with users on any other instance in the fediverse. Instances hosted by different social networking services, each of the entities 102, 104, may communicate with one another as well.

As part of the entities 102, 104 agreeing to collaborate, the entities 102, 104 can agree to receive queries regarding protected knowledge consistent with binding legal agreements. As part of the entities 102, 104 agreeing to collaborate, the entities 102, 104 can agreed to receiving protected advertising from the collaboration partners. The protected advertising is for requests for partnership to achieve a goal, generation of a new product or IP that is available for licensing, production, or the like.

The communications 138 can be generated via cryptographically secure communications protocols (certificates, keys, WebFinger federated identity discovery, or the like).

The documents can be made accessible via a fediverse connector for query, advertising, and real-time collaboration. The data that is made accessible by the entity 102, 104 can be tagged based on IP category. The data that is made accessible by the entity 102, 104 can include one or more honeytokens inserted therein. Honeytokens are an advanced document watermarking technique which enables automated detection of data theft.

The collaboration architecture 106 can audit logging of data access across business boundaries and generate corresponding reports that are accessible by all relevant parties. The collaboration architecture 106 can provide recommendations for purchase order or invoicing payment support including any tailoring (unique transaction identification ID tags). The collaboration architecture 106 can model entity-to-entity collaboration, enhancing growth and development opportunities. The collaboration architecture can provide a visualization of a current state of entity operations, creating recommendations for future state (including alternative suppliers), supply chain risk analyses, among others.

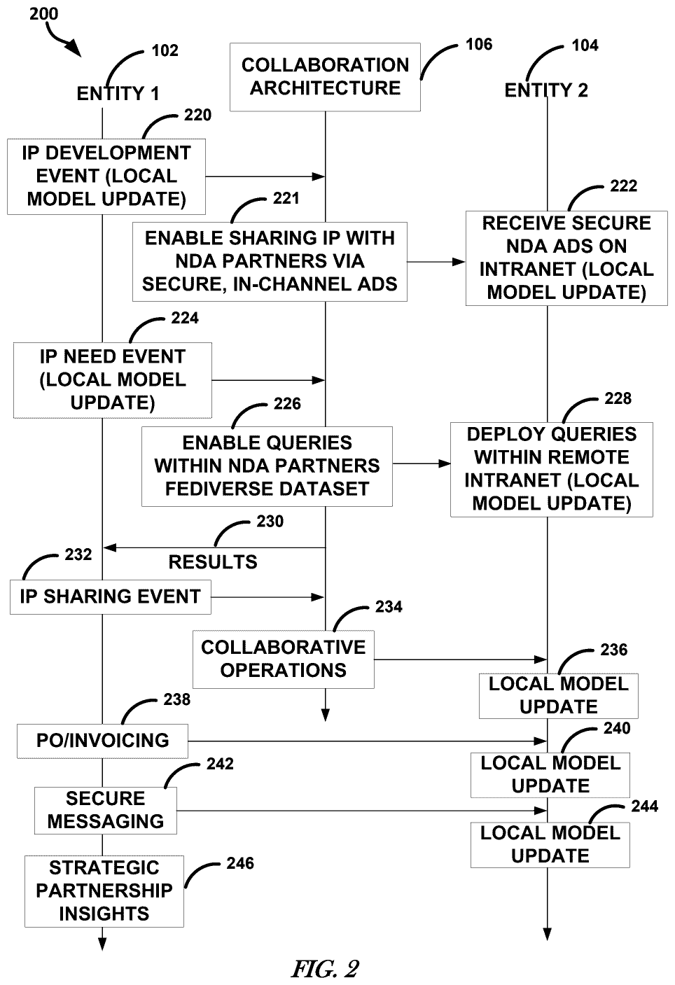

The collaboration architecture can support “auto-IDIQ” such as to determine how to become a supplier of an entity, expand into another market, or a combination thereof in compliance with prerequisites for collaboration and data sharing provided by the entity FIG. 2 illustrates, by way of example, a diagram of communications and operations 200 for using the collaboration architecture 106. The communications and operations 200 as illustrated include the first entity 102 generating an IP development event 220. The local ML model service is updated to reflect the IP development event 220. The IP development event 220 can include filing or issuing of a patent, product development, targeted research & development activity, publishing a paper, video, or the like, filing or issuing of a trademark, generation of a draft agreement, or the like. The collaboration architecture 106 determines which other entities are allowed to access the data associated with the IP development event 220. The collaboration architecture 106 establishes and manages an access policy associated with the IP development event 220 such that entities that have sufficient credential can access the IP of the IP development event. The credentials can include the entity being (i) a collaboration partner (ii) interested in collaborating in the field associated with the IP development event 220 and (iii) have executed an NDA covering the IP of the IP development event can access the data associated with the IP development event 220. The collaboration architecture 106 can provide an in-channel communication to the entity 104 indicating that the IP development event 220 has occurred. In this way, the collaboration architecture 106 enables sharing IP with NDA partners via secure, in-channel ads at operation 221. The entity 104 receives secure NDA-protected ads on their intranet at operation 222. The local model of the entity 104 is updated to reflect that the ad was presented and the response of the entity 104.

The entity 102 is illustrated as generating an IP need event at operation 224. An IP need event is an indication that the entity 102 is looking for an innovation, development, solution to a problem and/or addressing a gap in capability. The local model of the entity 102 can be updated to reflect the IP need event. The IP need event at operation 224 can cause the collaboration architecture 106 to generate a query 226 that searches potential collaboration partners under sufficient NDA and within the fediverse for the IP indicated by the IP need event. The query is provided 228 to other entities that have setup collaboration agreements with the entity 104. The query can be executed by the entity 104 that chooses to execute the query. If any of the queries result in a positive match, positive results 230 indicating potential collaboration partners and the corresponding IP can be provided to the entity 102.

If the entity 102 chooses to collaborate with the entity 104 regarding the IP, an IP sharing event 232 can occur. The IP sharing event 232 can indicate the desire for two of the entities to work together. The collaboration architecture 106, using the LLM, can determine the scope of the collaboration, generate agreements, such as an NDA, licensing, development, joint venture, other agreement, or a combination thereof. The entities 102, 104 can negotiate terms of the agreement through the collaboration architecture 106. Corresponding local models of the entities 102, 104 can be updated in accord with the collaboration agreement at operation 236. The collaborators can then perform collaboration operations 234 to achieve a collaboration goal.

The entities 102, 104 can generate purchase orders (POs) or invoices 238 with the aid of the collaboration architecture. Corresponding local models of the entities 102, 104 can be updated in accord with the POs or invoices at operation 240.

The entities 102, 104 can directly and securely message 242 each other through their corresponding fediverse instances. The direct messaging can be in support of the goal indicated by the IP need event 224. Corresponding local models of the entities 102, 104 can be updated at operation 244 in accord with the secure messages 242.

Strategic partnership insights 246 can be generated through the collaboration. The strategic partnership insights 236 can relate to the IP associated with the IP need event 224.

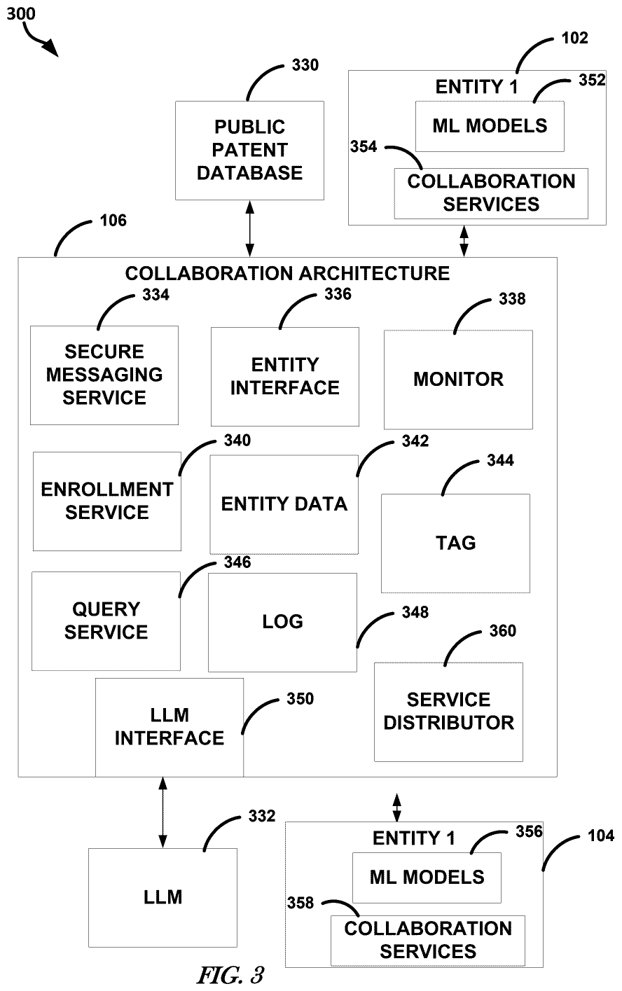

FIG. 3 illustrates, by way of example, a diagram of an embodiment of a system 300 for enabling the collaboration of FIGS. 1 and 2. The system 300 as illustrated includes the entities 102, 104 and the collaboration architecture 106 from the FIGS. 1 and 2. The system 300 as illustrated further includes a public patent database 330 and an LLM 332. The public patent database 330 can include Google Patents, the United States Patent and Trademark Office patent database, a combination thereof, or the like. The public patent database 330 can include patents and associated metadata. The metadata can include information like technology category, art unit, inventor name, assignee name, date of issuance, date of abandonment, a combination thereof, or the like.

Each of the respective entities 102, 104 is illustrated as including respective ML models 352, 356 and collaboration services 354, 358. As discussed, the collaboration architecture 106 facilitates automated sharing of IP with entities 102, 104. IP typically resides in one or more data repositories which are under the full control/ownership of the entity 102, 104 (not a third party provider). The IP repository for each of the entities 102, 104 is not illustrated so as to not obscure the view.

A “top level monitoring” agent, one of the ML model 352, 356, is installed with access to the IP repository of a given entity 102, 104. This agent acts on behalf of the IP owner and has permissive data access rights to all data in the IP repository. The agent scans the IP repository when data is added or changed and generates an IP category for the scanned content (using the LLM 332 in some embodiments). The agent cross-references the identified IP category with IP categories referenced in external agreements. If a match is found between the identified IP category and an IP category referenced in another agreement, an alert is generated to the repository owner. The alert can be informational as part of an automated process or require user interaction to continue. The relevant IP-bearing data is then presented to a subordinate agent, another one of the ML models 352, 356, also installed within the context of the IP repository. The subordinate agent acts on behalf of the collaboration partner and includes a model trained on the collaboration partner goals and other IP evaluation criteria.

The subordinate agent generates an interest score based on the presented IP-bearing content and its associated IP evaluation criteria model. If the subordinate agent determines the content is of interest to the collaboration partner, it will generate an alert to the IP owner. The alert can be informational as part of an automated process or require user interaction to proceed. A summary of the IP bearing data is generated using language and terms relevant to the domain of the collaboration partner. The IP owner can have the option to edit or annotate the summary with custom content. The summary can be transmitted to the collaboration partner for consideration using secure communications. The IP owner can also be presented with an option to perform an action that benefits the operators of the collaboration architecture 106 which boosts engagement with the IP content within the network of the collaboration partner. If the collaboration partner decides to engage with the IP content further, am agreement can be generated by the LLM 332 for enhanced, full access.

An access to data of an entity can require legal protections commensurate with terms of the agreements. Communications between IP owner to a collaboration partner can integrate digital watermarking to uniquely identify the delivered data. All communications can be logged by the monitor 338 and associated with a given collaboration in the log 348. In some embodiments, the log 348 uses distributed ledger technologies. The log 348 can include unique entity identities participating in the communications. In some embodiments, user identities are managed via decentralized distributed identity services. In some embodiments, communications between IP owner and a collaboration partner agent is executed via a fediverse ActivityPub protocol. In some embodiments, alerting to the IP owner is via an on-premise “social media” capability. The IP owner social media capability connects to a compatible social media capability installed on the NDA partner infrastructure. This connectivity between social media instances installed on segregated infrastructure can use fediverse ActivityPub protocols. An alert related to interesting IP, as determined by the agent, can be received on the collaboration partner infrastructure. The summary information can be stored in a cryptographically secured repository. Summary information can be used to generate an advertisement which is deployed to the collaboration partner's fediverse instance. The frequency of the advertisement presentation and who is targeted with the advertisement can be augmented from both interest/applicability scores and boosting by a given IP owner. The presented advertisement may include optional details on why an ad was selected for that fediverse access session. Advertisement clicking and content dwell time can be used to update the agent's model for assessing the collaboration partner interest, topical engagement, or a combination thereof.

The LLM 332 is a generative model that determines a most likely series of next tokens based on a prompt. Example LLMs include those provided by The LLM 332 is accessed, by the collaboration architecture 106, through the LLM interface 350. The LLM interface 350 receives prompt data through entity interface 336. The LLM interface 350 generates and formats a prompt for the LLM 332. The prompt can be for the LLM 332 to generate a document, alter a document, or the like. The prompt can include restrictions or other constraints, goals, or the like of the entities indicated by entity data 342. The prompt can include a goal for the LLM 332.

The secure messaging service 334 is an encrypted communications channel between the entities 102, 104. The entities 102, 104 can directly message each other over the secure messaging service 334. An instance of the secure messaging service 334 can be loaded onto computer devices of the entity 102 and computer devices of the entity 104. The entities 102, 104 can exchange encryption keys, such as through the collaboration architecture 106, and then exchange encrypted communications via the secure messaging service 334 instances loaded onto their computer devices.

The entity interface 336 is a UI through which the entities access functionality of the collaboration architecture 106. The entity interface 336 allows the entities 102, 104 to provide data to be stored in the entity data 342, discover technological needs of themselves, discover technological capabilities of other entities enrolled with the collaboration architecture 106, publish and search for research and development investments, products, and services, discover collaborators and corresponding collaborator restrictions, leverage the LLM to generate documents, negotiate, via the LLM, terms of documents, share data with entities, sign documents, generate POs, invoices, or the like, among other functionality.

A monitor 338 generates a log 348 of all activity on the collaboration architecture 106. The log 348 details operations of the entities 102, 104 conducted through the entity interface 336. The log 348, along with the entity data 342, can be used by the monitor 338 to audit whether any terms of any of the agreements are being violated. The monitor 338 can issue an alert, via the entity interface 336, if a potential violation is detected. The alert can be issued to the entities associated with the agreement that is potentially violated.

An enrollment service 340 performs the operations of entity validation and determining whether or not to accept an entity as a user. The enrollment service 340 can store data received in the enrollment process in the entity data 342.

A tag service 344 adds metadata to the entity data 342. The metadata indicates categories of the data, such as a sensitivity level (e.g., public, internal, classified, restricted, or the like), a topic (e.g., a patent technology category associated with IP, an art unit associated with the IP, or the like), an identification associated with an entity that originated the data, entities that are allowed or prohibited from accessing the data, or the like.

The query service 346 generates queries that can be executed by the entities 102, 104 on their own data at the discretion of the entities 102, 104. The query service 346 can generate queries in accord with the computer storage devices used by the entities in their own fediverse instances.

A service distributor 360 provides the collaboration services 354, 358 software programs to the entities 102, 104. The service distributor 360 provides the ML models, IM, email, entity interfaces, other programs, or a combination thereof that are relevant to the collaboration between the entities 102, 104. What is relevant to a given entity is determined based on the enrollment data provided to the enrollment service 340 and any agreements between the entities regarding a given collaboration.

The system 300 can leverage USPTO invention category system ontologies to identify collaboration partners. The system 300 provides an intermediary for Web3 distributed zero trust network interaction. Using the system 300, there is no centralized storage of sensitive business data. This is because the system can use an InterPlanetary File System (IPFS). Using the system 300, each entity maintains independent but synced copies of all shared content. The system 300 can leverage a fediverse ActivityPub capability for message routing and identity services.

All data provided through the system 300 can be signed by the author and the interactions with the data can be logged, by the monitor 338, enabling digital forensics. The tags 344 can include tags based on NDA terms, such as entities that are under sufficient NDA to view the corresponding data. Using the system 300, the entities can create just-in-time entity-to-entity IM, email, collaborative document editing, invoicing arrangements, a combination thereof, or the like.

The monitor 338 provides continuous monitoring and protection of proprietary data. The shared documents can include honeytokens and can leverage decentralized identity.

The system 300 improves efficiency and security and reduces time for generating and negotiating agreements between the entities 102, 104. Encryption and technical data protection is built into the agreements using the system 300. The system 300 enables just-in-time secure digital collaboration and disaster recovery data resiliency.

The system 300 supports supply chain operations, such as representations and certifications, terms and conditions, quality assurance requirements, invoicing, event notifications, a combination thereof, or the like. Using auto-IDIQ can be used by suppliers to quickly get “pre-approved” for contracting with another entity enrolled with the collaboration architecture 106.

The system 300 incentivizes creating a map of entity-to-entity relationships across global supply chains such as for supply chain risk management (SCRM). The system accelerates innovation such as by helping entities discover new collaboration partners and sources of technical expertise, solve technical challenges while integrating deployed new and legacy systems, a combination thereof or the like. Using the system 300, entities can quickly identify entity expertise and capabilities and setup contracts with other entities.

Using the system 300, entities can expand and diversify their supplier bases through negotiations at scale. The system 300 is applicable to generating commercial licenses. The system 300 can leverage other legacy technologies, such as LinkedIn, Adobe PDF digital signing, DocuSign, Meta Threads (federated social networks) or the like.

The collaboration architecture 106 can be accessible through a Zero Trust Endpoint Network Security (ZTENS) network, which is described in U.S. Pat. No. 11,848,964 titled “Zero Trust End Point Network Security Device” and filed on Jan. 26, 2021, which is incorporated herein by reference in its entirety.

The collaboration architecture 106 enables a federated entity collaboration network (FECN) that provides accelerated discovery of technical capabilities and gaps, and instantiation of collaborative communications infrastructure using machine learning and decentralized Web3 capabilities across entity trust boundaries. Traditionally, collaboration between entities (e.g., legal entities) requires significant human-intensive processes which are often ad hoc in nature. Discovery of collaborators involves in-person meetings, custom search engine queries, and third-party introductions. Data sharing is facilitated through PIAs. Developing a PIA with terms acceptable to all parties is a labor-intensive process that scales exponentially, proportional to the number of parties on the agreement. Mutually acceptable security protocols for digital data sharing is ad hoc or non-existent and often conducted via email. Restrictions on data sharing (export controlled, classified, personal identifiable information, personal financial information, etc.), including the ability and willingness of all parties to send or to receive such data, is often discovered late in the process. Further complications for business collaboration include negotiating licensing agreements, terms and conditions, payment and invoicing, quality control (QC) measures, service level agreements (SLAs), warranties, and insurance requirements. Each of these require labor-intensive processes to negotiate and facilitate the transfer of tangible and intangible goods across legal entity trust domains. Finally, models do not exist to fully describe these business data transactions, trust boundaries, and the enabling legal agreements for system of systems and mission engineering problem domains. The inability to rapidly discover subject matter expertise, contractual agreements, and collaboration opportunities combined with the inability to rapidly create multi-party legal relationships and the supporting digital information sharing infrastructure significantly hinders the execution of mission engineering.

The collaboration architecture 106 is an AI-enabled social-professional network facilitating collaboration between entities (vice individuals or representatives of entities). The collaboration architecture 106 provides:
AI-enabled mediation of multi-party agreements to enable secure, sanctioned information sharing
AI-enabled tagging of data shared between parties to specific IP categories defined in the PIA Just-in-Time creation of decentralized communication infrastructure between all parties which includes multi-party cryptographic key management
Logging transactions on a distributed ledger that is accessible to all legal entities on the multi-party PIA, enabling audits and digital forensics
Distributed identity services and advanced watermarking of data shared between parties to facilitate audits of data accesses across legal entities
Financial transactions between entitles (invoices, purchase orders, etc.) as a countermeasure to purchase order fraud
The collaboration architecture 106 does not store any data of participating parties, all data is stored on infrastructure defined by participating parties

The monitor 338 can determine when an agreement expires is voided or nullified. NDAs are often worded to allow the receiving company to retain the information after the protection period expires.

Data retention or access after an NDA violation can be situation dependent and can be dependent on time-based crypto services. Advertisements between entities can include sponsored top hit links, encrypted capabilities revealed to NDA partners, ads live on company infrastructure, served via IPFS, can use ZTENS like routing too for the data fabric. The collaboration architecture 106 allows entities to agree to terms and conditions via popup, while logging actions and who agreed to what.

The collaboration architecture 106 can provide enrollment, installation of infrastructure components on the entities 102, 104 computer networks, can be a public cloud instance, subscription-based, or on premises, provide recommendations, such as published patents, agreement-protected suggestions, data routing, adding new protected data sources, integrated time stamping and tracking against agreement expiration date, protected data source routing, time-dependent IP/port, loaded with max number of routes allowed, integrated USPTO data tagging for multi-level storage data rights protection, remote authenticated query with curated results and data-owner filtering and analysis (web assembly (WASM) powered), on-premises intrusion detection systems (IDS) and auditing, among others.

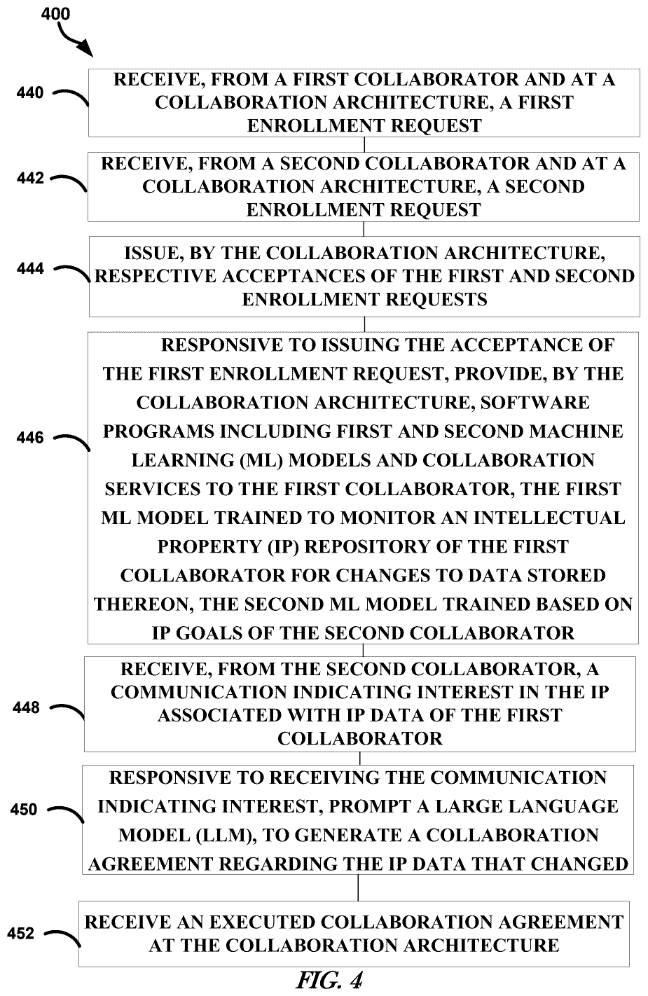

FIG. 4 illustrates, by way of example, a diagram of an embodiment of a method 400 for secure, federated collaboration. The method 400 as illustrated includes receiving, from a first collaborator and at a collaboration architecture, a first enrollment request, at operation 440; receiving, from a second collaborator and at a collaboration architecture, a second enrollment request, at operation 442; issuing, by the collaboration architecture, respective acceptances of the first and second enrollment requests, at operation 444; responsive to issuing the acceptance of the first enrollment request, providing, by the collaboration architecture, software programs including first and second machine learning (ML) models and collaboration services to the first collaborator, the first ML model trained to monitor an intellectual property (IP) repository of the first collaborator for changes to data stored thereon, the second ML model trained based on IP goals of the second collaborator, at operation 446; receiving, from the second collaborator, a communication indicating interest in the IP associated with IP data of the first collaborator, at operation 448; responsive to receiving the communication indicating interest, prompting a large language model (LLM), to generate a collaboration agreement regarding the IP data that changed, at operation 450; and receiving an executed collaboration agreement at the collaboration architecture, at operation 452.

The first ML model can be trained to generate an IP category for any data that has changed in the IP repository. The method 400 can further include identifying, by the first ML model, that the IP category is referenced in any collaboration agreements of the first collaborator.

The method 400 can further include generating, by the second ML model, an interest score indicating a level of interest the second collaborator has in the data that changed. The method 400 can further include issuing, by the second ML model and responsive to determining the interest score is greater than a specified threshold, a communication, to the second collaborator, indicating the IP data that changed.

The communication can be issued between a network of the first collaborator and to a network of the second collaborator that operate as part of a collection of interconnected, decentralized social networking services. The communication can include a summary of the IP associated with the IP data that changed.

The prompt can include constraints of the first collaborator and the second collaborator provided during enrollment. The method 400 can further include monitoring, by a monitor of the collaboration architecture, for a violation of the collaboration agreement. The monitoring can further include analyzing a log of activity of the first and second collaborators and the agreement.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The first ML model, second ML model, or other model of the ML models 352, 356, LLM, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result.

This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

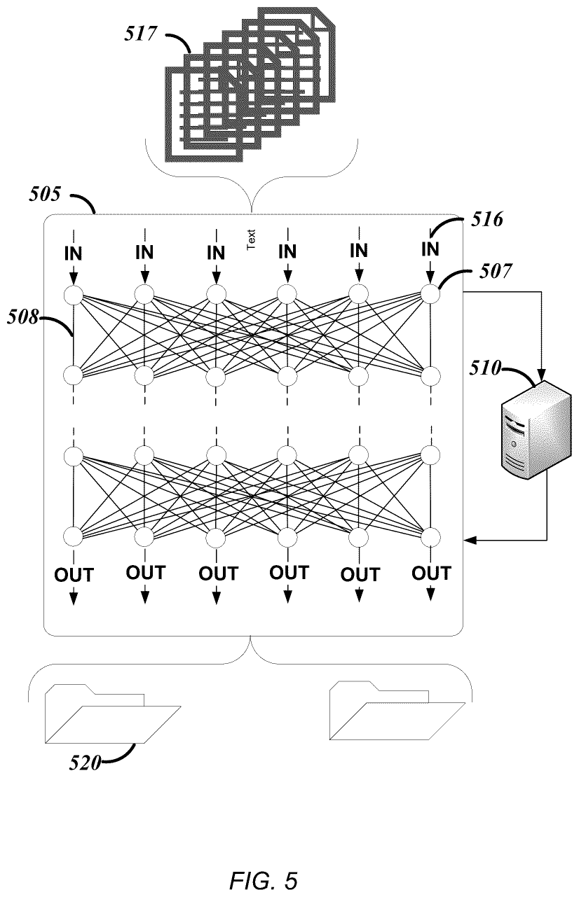

FIG. 5 is a block diagram of an example of an environment including a system for neural network (NN) training. The system includes an artificial NN (ANN) 505 that is trained using a processing node 510. The processing node 510 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 505, or even different nodes 507 within layers. Thus, a set of processing nodes 510 is arranged to perform the training of the ANN 505. One or more ML models of the ML models 352, 356, the LLM 332, a combination thereof, or the like, can be trained using the system.

The set of processing nodes 510 is arranged to receive a training set 517 for the ANN 505. The ANN 505 comprises a set of nodes 507 arranged in layers (illustrated as rows of nodes 507) and a set of inter-node weights 508 (e.g., parameters) between nodes in the set of nodes. In an example, the training set 517 is a subset of a complete training set. Here, the subset may enable processing nodes with limited storage resources to participate in training the ANN 505.

The training data may include multiple numerical values representative of a domain, such as an image feature, or the like. Each value of the training or input 517 to be classified after ANN 505 is trained, is provided to a corresponding node 507 in the first layer or input layer of ANN 505. The values propagate through the layers and are changed by the objective function.

As noted, the set of processing nodes is arranged to train the neural network to create a trained neural network. After the ANN is trained, data input into the ANN will produce valid classifications 520 (e.g., the input data 517 will be assigned into categories), for example. The training performed by the set of processing nodes 507 is iterative. In an example, each iteration of the training the ANN 505 is performed independently between layers of the ANN 505. Thus, two distinct layers may be processed in parallel by different members of the set of processing nodes. In an example, different layers of the ANN 505 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 507 (e.g., neurons) are trained independently. In an example, the nodes are trained on different hardware.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

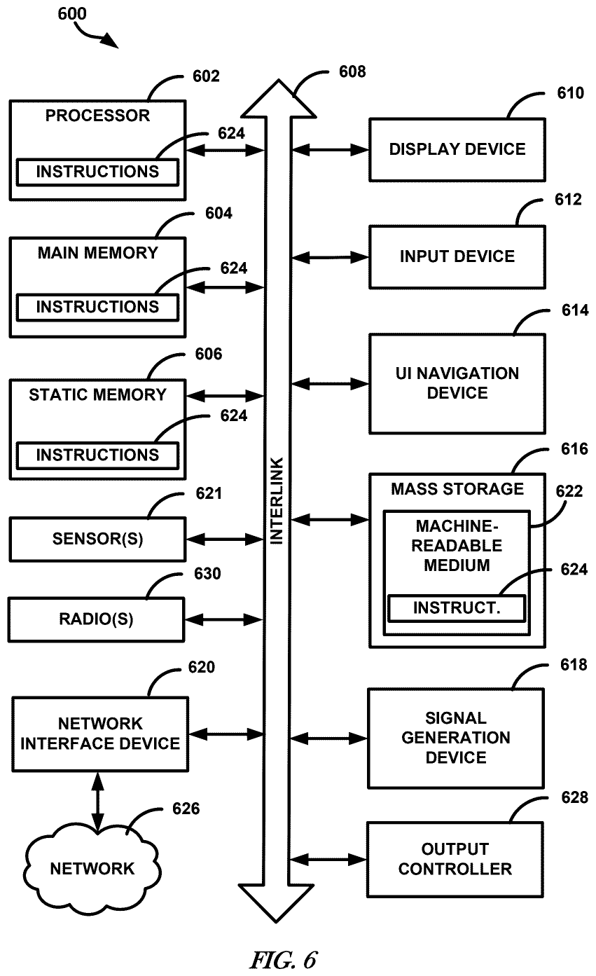

FIG. 6 illustrates, by way of example, a block diagram of an embodiment of a machine in the example form of a computer system 600 within which instructions, for causing the machine to perform any one or more of the methodologies discussed herein, may be executed. One or more of the communications or operations of the FIGS. 1 and 2, the ML models 352, 356, collaboration services 354, 358, secure messaging service 334, entity interface 336, monitor 338, enrollment service 340, tag 344, query service 346, log 348, LLM interface 350, service distributor 360, LLM 332, method 400, NN training system of FIG. 5, or a component or operation thereof can be implemented or performed by the computer system 600. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 621 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 604 and a static memory 606, which communicate with each other via a bus 608. The memory 604, 606 can store parameters (sometimes called weights) that define operations of a component of the system 600. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker), a network interface device 620, and radios 630 such as Bluetooth, WWAN, WLAN, and NFC, permitting the application of security controls on such protocols.

The machine 600 as illustrated includes an output controller 628. The output controller 628 manages data flow to/from the machine 600. The output controller 628 is sometimes called a device controller, with software that directly interacts with the output controller 628 being called a device driver.

### Machine-Readable Medium

The disk drive unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604, the static memory 606, and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Example

Example 1 can include a secure, federated method of collaboration, the method comprising receiving, from a first collaborator and at a collaboration architecture, a first enrollment request, receiving, from a second collaborator and at a collaboration architecture, a second enrollment request, issuing, by the collaboration architecture, respective acceptances of the first and second enrollment requests, responsive to issuing the acceptance of the first enrollment request, providing, by the collaboration architecture, software programs including first and second machine learning (ML) models and collaboration services to the first collaborator, the first ML model trained to monitor an intellectual property (IP) repository of the first collaborator for changes to data stored thereon, the second ML model trained based on IP goals of the second collaborator, receiving, from the second collaborator, a communication indicating interest in the IP associated with IP data of the first collaborator, responsive to receive the communication indicating interest, prompting a large language model (LLM), to generate a collaboration agreement regarding the IP data that changed, and receiving an executed collaboration agreement at the collaboration architecture.

In Example 2, Example 1 further includes, wherein the first ML model is trained to generate an IP category for any data that has changed in the IP repository.

In Example 3, Example 2 further includes identifying, by the first ML model, that the IP category is referenced in any collaboration agreements of the first collaborator.

In Example 4, Example 3 further includes generating, by the second ML model, an interest score indicating a level of interest the second collaborator has in the data that changed, and issuing, by the second ML model and responsive to determining the interest score is greater than a specified threshold, a communication, to the second collaborator, indicating the IP data that changed.

In Example 5, Example 4 further includes, wherein the communication is issued between a network of the first collaborator and to a network of the second collaborator that operate as part of a collection of interconnected, decentralized social networking services.

In Example 6, at least one of Examples 4-5 further includes, wherein the communication includes a summary of the IP associated with the IP data that changed.

In Example 7, at least one of Examples 1-6 further includes, wherein the prompt includes constraints of the first collaborator and the second collaborator provided during enrollment.

In Example 8, Example 7 further includes monitoring, by a monitor of the collaboration architecture, for a violation of the collaboration agreement.

In Example 9, Example 8 further includes, wherein the monitoring includes analyzing a log of activity of the first and second collaborators and the agreement.

Example 10 includes a collaboration architecture for federated collaboration, the collaboration architecture including an enrollment service configured to: receive, from a first collaborator, a first enrollment request, receive, from a second collaborator, a second enrollment request, and issue respective acceptances of the first and second enrollment requests; a service distributor configured to: responsive to issuing the acceptance of the first enrollment request, provide software programs including first and second machine learning (ML) models and collaboration services to the first collaborator, the first ML model trained to monitor an intellectual property (IP) repository of the first collaborator for changes to data stored thereon, the second ML model trained based on IP goals of the second collaborator; an entity interface configured to: receive, from the second collaborator, a communication indicating interest in the IP associated with IP data of the first collaborator; and a large language model (LLM) interface configured to: responsive to receive the communication indicating interest, prompt a large language model (LLM), to generate a collaboration agreement regarding the IP data that changed, and receive an executed collaboration agreement at the collaboration architecture.

In Example 11, Example 10 further includes, wherein the first ML model is trained to generate an IP category for any data that has changed in the IP repository.

In Example 12, Example 11 further includes identifying, by the first ML model, that the IP category is referenced in any collaboration agreements of the first collaborator.

In Example 13, Example 12 further includes, wherein the second ML model is further configured to generate an interest score indicating a level of interest the second collaborator has in the data that changed, and issue, responsive to determining the interest score is greater than a specified threshold, a communication, to the second collaborator, indicating the IP data that changed.

In Example 14, Example 13 further includes, wherein the communication is issued between a network of the first collaborator and to a network of the second collaborator that operate as part of a collection of interconnected, decentralized social networking services.

In Example 15, at least one of Examples 13-14 further includes, wherein the communication includes a summary of the IP associated with the IP data that changed.

Example 16 includes a non-transitory machine-readable medium including instructions that, when executed by a machine, cause the machine to perform operations for secure, federated collaboration, the operations comprising receiving, from a first collaborator and at a collaboration architecture, a first enrollment request, receiving, from a second collaborator and at a collaboration architecture, a second enrollment request, issuing, by the collaboration architecture, respective acceptances of the first and second enrollment requests, responsive to issuing the acceptance of the first enrollment request, providing, by the collaboration architecture, software programs including first and second machine learning (ML) models and collaboration services to the first collaborator, the first ML model trained to monitor an intellectual property (IP) repository of the first collaborator for changes to data stored thereon, the second ML model trained based on IP goals of the second collaborator, receiving, from the second collaborator, a communication indicating interest in the IP associated with IP data of the first collaborator, responsive to receiving the communication indicating interest, prompting a large language model (LLM), to generate a collaboration agreement regarding the IP data that changed, and receiving an executed collaboration agreement at the collaboration architecture.

In Example 17, Example 16 further includes, wherein the prompting includes constraints of the first collaborator and the second collaborator provided during enrollment.

In Example 18, Example 17 further includes, wherein the operations further comprise monitoring, by a monitor of the collaboration architecture, for a violation of the collaboration agreement.

In Example 19, Example 18 further includes, wherein the monitoring includes analyzing a log of activity of the first and second collaborators and the agreement.

In Example 20, at least one of Examples 16-19 further includes, wherein the first ML model is trained to generate an IP category for any data that has changed in the IP repository and the operations further comprise generating, by the second ML model, an interest score indicating a level of interest the second collaborator has in the data that changed, and issuing, by the second ML model and responsive to determining the interest score is greater than a specified threshold, a communication, to the second collaborator, indicating the IP data that changed.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A secure, federated method of collaboration, the method comprising:
receiving, from a first collaborator and at a collaboration architecture, a first enrollment request;
receiving, from a second collaborator and at a collaboration architecture, a second enrollment request;
issuing, by the collaboration architecture, respective acceptances of the first and second enrollment requests;
responsive to issuing the acceptance of the first enrollment request, providing, by the collaboration architecture, software programs including first and second machine learning (ML) models and collaboration services to the first collaborator, the first ML model trained to monitor an intellectual property (IP) repository of the first collaborator for changes to data stored thereon, the second ML model trained based on IP goals of the second collaborator;
receiving, from the second collaborator, a communication indicating interest in the IP associated with IP data of the first collaborator;
responsive to receiving the communication indicating interest, prompting a large language model (LLM), to generate a collaboration agreement regarding the IP data that changed; and
receiving an executed collaboration agreement at the collaboration architecture.

2. The method of claim 1, wherein the first ML model is trained to generate an IP category for any data that has changed in the IP repository.

3. The method of claim 2, further comprising identifying, by the first ML model, that the IP category is referenced in any collaboration agreements of the first collaborator.

4. The method of claim 3, further comprising:
generating, by the second ML model, an interest score indicating a level of interest the second collaborator has in the IP data that changed; and
issuing, by the second ML model and responsive to determining the interest score is greater than a specified threshold, a communication, to the second collaborator, indicating the IP data that changed.

5. The method of claim 4, wherein the communication is issued between a network of the first collaborator and to a network of the second collaborator that operate as part of a collection of interconnected, decentralized social networking services.

6. The method of claim 4, wherein the communication includes a summary of the IP associated with the IP data that changed.

7. The method of claim 1, wherein the prompt includes constraints of the first collaborator and the second collaborator provided during enrollment.

8. The method of claim 7, further comprising monitoring, by a monitor of the collaboration architecture, for a violation of the collaboration agreement.

9. The method of claim 8, wherein the monitoring includes analyzing a log of activity of the first and second collaborators and the agreement.

10. A collaboration architecture for federated collaboration, the collaboration architecture including:
an enrollment service module configured to:
receive, from a first collaborator, a first enrollment request;
receive, from a second collaborator, a second enrollment request;
issue respective acceptances of the first and second enrollment requests;
a service distributor configured to:
responsive to issuing the acceptance of the first enrollment request, provide software programs including first and second machine learning (ML) models and collaboration services to the first collaborator, the first ML model trained to monitor an intellectual property (IP) repository of the first collaborator for changes to data stored thereon, the second ML model trained based on IP goals of the second collaborator;
an entity interface configured to:
receive, from the second collaborator, a communication indicating interest in the IP associated with IP data of the first collaborator; and
a large language model (LLM) interface configured to:
responsive to receiving the communication indicating interest, prompt a large language model (LLM), to generate a collaboration agreement regarding the IP data that changed; and
receive an executed collaboration agreement at the collaboration architecture.

11. The collaboration architecture of claim 10, wherein the first ML model is trained to generate an IP category for any data that has changed in the IP repository.

12. The collaboration architecture of claim 11, further comprising identifying, by the first ML model, that the IP category is referenced in any collaboration agreements of the first collaborator.

13. The collaboration architecture of claim 12, wherein the second ML model is further configured to:
generate an interest score indicating a level of interest the second collaborator has in the data that changed; and
issue, responsive to determining the interest score is greater than a specified threshold, a communication, to the second collaborator, indicating the IP data that changed.

14. The collaboration architecture of claim 13, wherein the communication is issued between a network of the first collaborator and to a network of the second collaborator that operate as part of a collection of interconnected, decentralized social networking services.

15. The collaboration architecture of claim 13, wherein the communication includes a summary of the IP associated with the IP data that changed.

16. A non-transitory machine-readable medium including instructions that, when executed by a machine, cause the machine to perform operations for secure, federated collaboration, the operations comprising:
receiving, from a first collaborator and at a collaboration architecture, a first enrollment request;
receiving, from a second collaborator and at a collaboration architecture, a second enrollment request;
issuing, by the collaboration architecture, respective acceptances of the first and second enrollment requests;
responsive to issuing the acceptance of the first enrollment request, providing, by the collaboration architecture, software programs including first and second machine learning (ML) models and collaboration services to the first collaborator;
the first ML model trained to monitor an intellectual property (IP) repository of the first collaborator for changes to data stored thereon;
the second ML model trained based on IP goals of the second collaborator;
receiving, from the second collaborator, a communication indicating interest in the IP associated with IP data of the first collaborator;
responsive to receiving the communication indicating interest, prompting a large language model (LLM), to generate a collaboration agreement regarding the IP data that changed; and
receiving an executed collaboration agreement at the collaboration architecture.

17. The non-transitory machine-readable medium of claim 16, wherein the prompting includes constraints of the first collaborator and the second collaborator provided during enrollment.

18. The non-transitory machine-readable medium of claim 17, wherein the operations further comprise monitoring, by a monitor of the collaboration architecture, for a violation of the collaboration agreement.

19. The non-transitory machine-readable medium of claim 18, wherein the monitoring includes analyzing a log of activity of the first and second collaborators and the agreement.

20. The non-transitory machine-readable medium of claim 16, wherein the first ML model is trained to generate an IP category for any data that has changed in the IP repository and the operations further comprise:
generating, by the second ML model, an interest score indicating a level of interest the second collaborator has in the data that changed; and
issuing, by the second ML model and responsive to determining the interest score is greater than a specified threshold, a communication, to the second collaborator, indicating the IP data that changed.
